(19) United States
(12) Patent Application Publication
(10) Pub. No.: US 2010/0309554 A1
(43) Pub. Date: Dec. 9, 2010

(54) COLOR SEPARATION MICROLENS AND COLOR SEPARATION GRATING

(75) Inventors: Shuichi Nagai, Osaka-fu (JP); Xinbing Liu, Acton, MA (US)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/477,325

(22) Filed: Jun. 3, 2009

(51) Int. Cl. G02B 5/18

(52) U.S. Cl. 359/568

(57) ABSTRACT

Color separation gratings, color separation microlenses and imaging arrays are provided. A color separation grating includes a transparent grating material having a grating formed therein. The transparent grating material has a first surface configured to receive incident light and a second surface opposite the first surface. The second surface is configured to pass selective separated colors from the incident light corresponding to different diffraction orders. The grating is formed in the first surface and includes a number of steps in a grating period and a number of sub-steps formed on each step. A combination of the number of steps and the number of sub-steps are selected to correspond to a number of diffraction orders produced by the color separation grating.

### FIELD OF INVENTION

The present invention relates to image sensors and, more particularly, to color separation gratings and color separation microlens, and methods of forming the same.

### BACKGROUND OF THE INVENTION

Image sensors are known, and find application in a wide variety of fields, such as consumer products, machine vision, robotics and navigation. Typically, the image sensor is used to convert an optical image to an electric signal. There are a number of different types of imagers, including charge coupled devices (CCDs) and complimentary metal oxide semiconductor (CMOS) devices.

In general, the image sensor includes an array of pixels (i.e. a pixel array), containing photodetectors such as photodiodes. Each pixel produces a signal corresponding to the intensity of light impinging on that pixel, when an image is focused on the array. The electric signals may be stored and/or processed, for example to display a corresponding image or otherwise used to provide information about the image. The image sensor may also include an array of microlenses (i.e., a microlens array), to focus the incident light onto respective pixels of the pixel array.

To detect color and to capture a color image, an absorptive color filter array (CFA) is typically positioned between the microlens array and the pixel array. For example, each pixel may be covered with a respective color filter, such as a red (R), green (G) or blue (B) filter. Thus, each pixel individually detects one of the colors passed by the respective color filter. Conventional color filters, however, typically have a poor transmission efficiency. For example, as little as one-third of the incident light may pass through each respective filter.

### SUMMARY OF THE INVENTION

The present invention relates to a color separation grating. The color separation grating includes a transparent grating material having a grating formed therein. The transparent grating material has a first surface configured to receive incident light and a second surface opposite the first surface, where the second surface is configured to pass selective separated colors from the incident light corresponding to different diffraction orders. The grating is formed in the first surface and includes a number of steps in a grating period and a number of sub-steps formed on each step. A combination of the number of steps and the number of sub-steps are selected to correspond to a number of diffraction orders produced by the color separation grating.

The present invention also relates to a color separation microlens. The color separation microlens includes a color separation grating and a lens. The color separation grating includes a transparent grating material having a grating formed therein. The transparent grating material has a first surface configured to receive incident light and a second surface opposite the first surface, where the second surface is configured to pass selective separated colors from the incident light corresponding to different diffraction orders. The grating is formed in the first surface and includes a number of steps in a grating period and a number of sub-steps formed on each step. The lens is positioned either proximate the first surface or proximate the second surface and is configured to focus the different diffraction orders onto respective separate focus spots on a common focal plane relative to the color separation grating. A combination of the number of steps and the number of sub-steps is selected to correspond to a number of diffraction orders produced by the color separation grating.

The present invention further relates to an imaging array including a color separation grating, a plurality of microlenses and a plurality of photodetectors. The color separation grating has a plurality of grating periods and includes a transparent grating material having a grating formed therein. The transparent grating material has a first surface configured to receive incident light and a second surface opposite the first surface, where the second surface is configured to pass selective separated colors from the incident light corresponding to different diffraction orders. The grating is formed in the first surface and includes a number of steps in each grating period and a number of sub-steps formed on each step. The plurality of microlenses are positioned either proximate the first surface or proximate the second surface and are configured to focus the different diffraction orders onto respective separate focus spots on a common focal plane relative to the color separation grating. The plurality of photodetectors are positioned at the separate focus spots to receive the respective different diffraction orders. A combination of the number of steps and the number of sub-steps is selected to correspond to a number of diffraction orders produced by the color separation grating.

### BRIEF DESCRIPTION OF THE DRAWINGS

The invention may be understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1A is a cross-section diagram of a conventional echelle-type grating relative to a pixel array;

FIG. 1B is a graph of transmittance as a function of wavelength for red, green and blue light diffracted through the conventional grating shown in FIG. 1A;

FIG. 2A is a cross-section diagram of a color separation grating, according to an exemplary embodiment of the present invention;

FIG. 2B is a graph of transmittance as a function of wavelength for red, green and blue light diffracted through the color separation grating shown in FIG. 2A;

FIG. 3 is a perspective diagram of an imaging array including the color separation grating shown in FIG. 2A, according to an exemplary embodiment of the present invention;

FIG. 4A is a cross-section diagram of a color separation grating, according to another exemplary embodiment of the present invention;

FIG. 4B is a graph of transmittance as a function of wavelength for green light diffracted through the conventional grating shown in FIG. 1A and the exemplary color separation grating shown in FIG. 4A;

FIGS. 4C and 4D are cross-section diagrams of color separation gratings, according to further exemplary embodiments of the present invention;

FIGS. 5A, 5B and 5C are cross-section diagrams of combinations of a microlens and color separation grating, according to exemplary embodiments of the present invention;

FIG. 6A is a ray-trace diagram showing an example illustrating light rays passed through a microlens and color separation grating, according to an exemplary embodiment of the present invention;

FIG. 6B is a graph of transmittance as a function of wavelength for light passed through the combination of the microlens and color separation grating shown in FIG. 6A;

FIG. 6C is an image of focus spots for red, green and blue light passed through the combination of the microlens and color separation grating shown in FIG. 6A as a function of wavelength and relative lateral offset;

FIG. 7A is a ray-trace diagram showing an example illustrating light rays passed through an integrated color separation microlens, according to another exemplary embodiment of the present invention; and

FIG. 7B is an image of focus spots for red, green and blue light passed through the integrated color separation microlens shown in FIG. 7A as a function of wavelength and relative lateral offset.

### DETAILED DESCRIPTION OF THE INVENTION

As described above, one technique for color imaging is to include a color filter array above the pixel array. This technique, however, is typically inefficient because a portion of incident light is lost on passing through the color filters. Another technique for color imaging is to combine a diffraction grating with a microlens array. For this technique, incident light is transmitted through the diffraction grating such that it is separated into its primary colors (e.g., red, green and blue colors) by the diffraction grating. The primary colors are directed to the respective photodetectors of the pixel array, where the microlens array aids in focusing of the primary colors onto the respective photodetectors of the pixel array. Although diffraction gratings that pass red, green and blue colors are described herein, it is understood that colors such as red, green and blue are mentioned for purposes of explanation and are not intended to limit the invention to these particular colors.

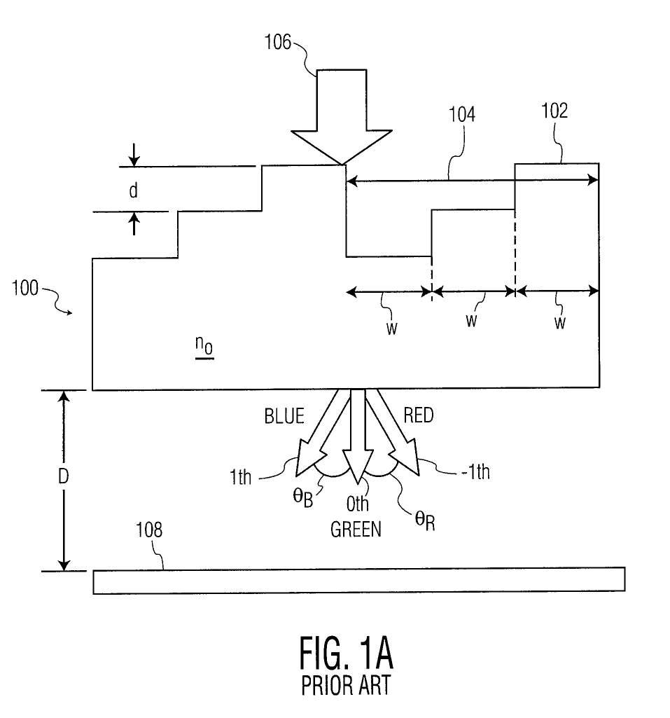

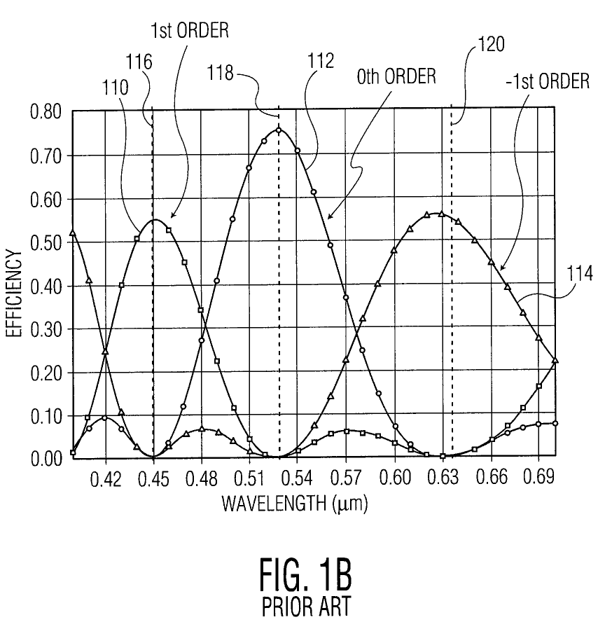

Referring to FIG. 1A, a conventional transmission echelle-type grating 100 relative to a pixel array 108 is shown. Grating 100 includes N steps 102 per grating period 104 and has a refractive index nₒ. Grating 100 may be formed from any suitable material transparent to visible light, such as glass or SiO₂.

In echelle-type grating 100, incident light 106 is separated into different colors corresponding to different diffraction orders. Each step 102 has a width w and a depth d. The depth d is related to an operating wavelength λ₀ and the index of refraction nₒ, shown in Eq. (1) as:

$$d = \frac{{λ}_{0}}{( {n}_{o} - 1 )} \qquad ( Eq . 1 )$$

Each step 102 introduces a phase shift of 2π at operating wavelength λ₀ such that light corresponding to the operating wavelength λ₀ passes through grating 100 with 0 order diffraction (i.e. undiffracted, with no lateral offset). For wavelengths corresponding to the ±1 orders of diffraction (i.e., λ₋₁ and λ₊₁) each step 102 introduces a phase shift relative to the operating wavelength λ₀. Accordingly, light corresponding to wavelength λ₋₁ (or wavelength λ₊₁) is diffracted through grating 100 and is laterally offset from light at operating wavelength λ₀ by a diffraction angle θ. Light corresponding to −1 order diffraction (i.e., wavelength λ₋₁) is diffracted at a diffraction angle θ similar to light corresponding to +1 order diffraction (i.e., wavelength λ₊₁), except that light at −1 order diffraction is diffracted in an opposite direction as light at +1 order diffraction.

For example, as shown in FIG. 1A, the operating wavelength λ₀ corresponds to green light. Accordingly, green light passes through grating 100 without any lateral offset, as 0 order diffraction. Red light (i.e., wavelength λ₋₁) is diffracted at diffraction angle θ_{R} at −1 order with a lateral offset to the right of the 0 order diffracted light. Blue light (i.e., wavelength λ₊₁) is diffracted at diffraction angle θ_{B} at +1 order with a lateral offset to the left of the 0 order diffracted light.

In general, light of wavelength λ is diffracted through grating 100 at diffraction angle θ as:

$$sin θ = \frac{m λ}{Λ} \qquad ( Eq . 2 )$$

where m is a positive or negative integer (including 0) that represents the diffraction order and Λ represents grating period 104. In general, operating wavelength λ₀ is diffracted with 0 order (i.e., is undiffracted), thus, it is not laterally offset. In contrast, wavelengths λₘ, where |m|>0, are laterally offset from the 0 order diffracted light by diffraction angle θ.

Example characteristics of conventional grating 100 are shown below in Table 1. A transmittance efficiency of grating 100 having the grating characteristics shown in Table 1 are described below with reference to FIG. 1B.

TABLE 1
Example characteristics for conventional grating 100

| Material | nₒ | w (μm) | d (μm) | Λ (μm) |
|---|---|---|---|---|
| SiO₂ | 1.46 | 0.33 | 2.3 | 10 |
| | | (0.34 for w*) | | |

Referring to FIG. 1B, graphs of transmittance curves 110 (for +1 order), 112 (for 0 order) and 114 for (−1 order) diffracted light as a function of wavelength are shown. Transmittance curve 110 corresponds to blue light, transmittance curve 112 corresponds to green light and transmittance curve 114 corresponds to red light. Vertical line 116 represents the wavelength of blue light (0.45 μm), vertical line 118 represents the wavelength of green light (0.53 μm) and vertical line 120 represents the wavelength of red light (0.64 μm). Accordingly, conventional grating 100 separates incident light 106 (FIG. 1A) into red, green and blue light as −1 order, 0 order and +1 order diffracted light, respectively.

Referring back to FIG. 1A, when grating 100 is used with pixel array 108, grating 100 is spaced apart from pixel array 108 by a distance D. The distance D may be selected such that the diffracted colors are substantially separated and are directed to the appropriate photodetectors. Accordingly, in order to obtain separations used by conventional imagers, the distance D between grating 100 and a pixel array is relatively large, for example, between about 4.5 to 5.5 μm. As one example, conventional grating 100 may be spaced from pixel array 108 by a distance D of 4.8 μm. In this example, if photodetectors in pixel array 108 have a width of about 5.6 μm, in order to obtain suitable color separation from grating 100, the diffraction angle θ may be about 30°.

On the other hand, it is desirable to position the diffraction grating 100 as close as possible to the pixel array, in order to produce a thinner and more compact image sensor. To obtain a thinner device, it is desirable to produce diffracted colors at a larger diffraction angle θ. A larger diffraction angle θ may be obtained, for example, by producing a color separation grating with a smaller grating period 104, as shown in (Eq. 2). Characteristics of a color separation grating 100 with a small grating period, however, are typically poor because the grating period is much closer to the dimensions of the operating wavelength λ₀.

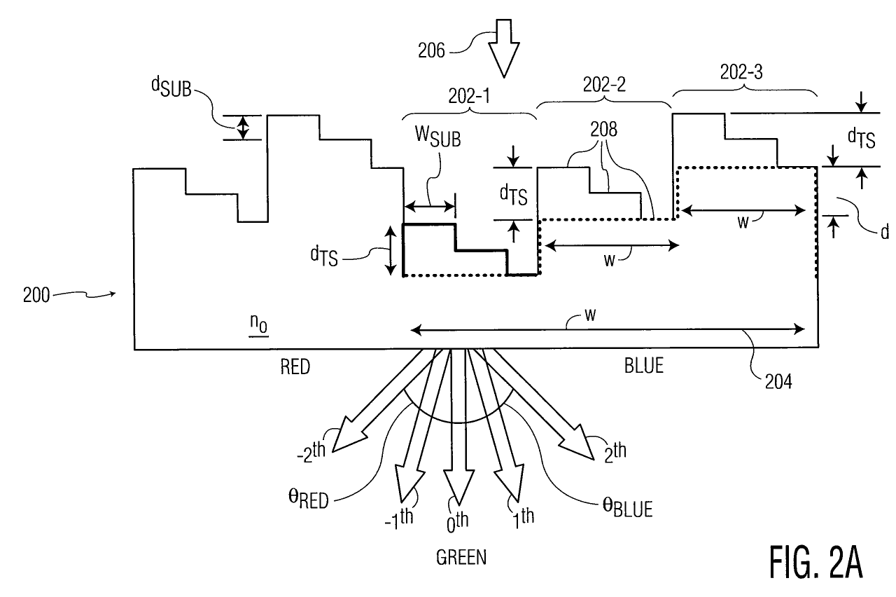

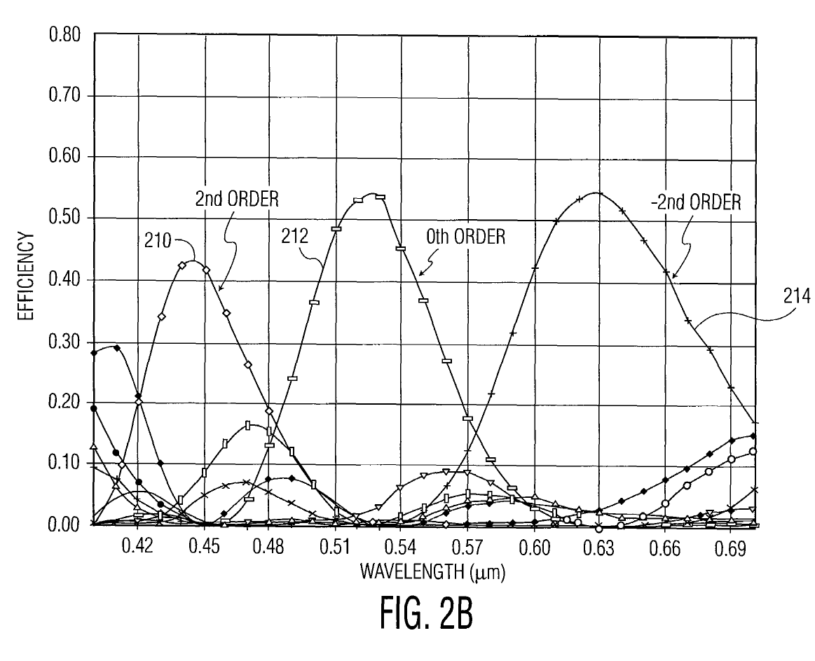

Referring next to FIG. 2A, a cross-section diagram is shown of an exemplary color separation grating 200, according to an exemplary embodiment of the present invention. Grating 200 includes N steps 202 per grating period 204 and has index of refraction nₒ. Each step 202 has a width w and a depth d. Each step 202 includes K sub-steps 208. Each sub-step 208 has a width w_{SUB} and a depth d_{SUB}, with a total sub-step depth d_{TS}. As shown in FIG. 2A, steps 202 monotonically increase with respect to each grating period 204. Sub-steps 208, in contrast, monotonically decrease for each step 202. Grating 200 may be formed from any suitable material transparent to visible light, such as glass or SiO₂.

As shown in FIG. 2A, incident light 206 is separated into red, green and blue light such that green light is diffracted at 0 order, whereas red light and blue light are diffracted at −2 and +2 orders, respectively. Because green light is diffracted at 0 order, it is not laterally offset and passes directly through grating 200. Red light and blue light, on the other hand, are diffracted into opposite orders (i.e., ±2). Therefore red diffracted light is laterally offset to one direction by diffraction angle θ_{RED} and blue diffracted light is laterally offset to the opposite direction by diffraction angle θ_{BLUE}. In general, the magnitude of the diffraction angles θ_{RED} and θ_{BLUE} are different, because the wavelengths of red light and blue light are different (and are related to the diffraction angle θ as shown in Eq. 2). Accordingly, red light and blue light have different lateral offsets from 0 order diffracted green light.

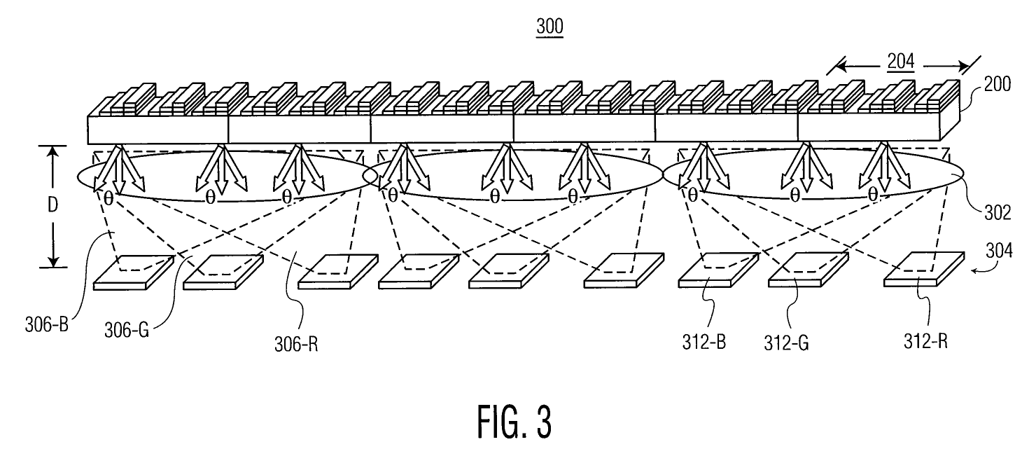

As shown in FIG. 2A, sub-steps 208 provide a higher order diffraction (i.e., ±2) as compared with conventional grating 100 (i.e., ±1) (FIG. 1A). The higher order color separation grating 200 provides larger diffraction angles θ_{RED}, θ_{BLUE} at ±2 order diffraction as compared with the diffraction angle θ of conventional grating 100 (FIG. 1A). Because color separation grating 200 produces larger diffraction angles, grating 200 may be positioned closer to a pixel array (such as pixel array 304 shown in FIG. 3).

In FIG. 2A, three steps (i.e., N=3) 202-1, 202-2 and 202-3 and three sub-steps 208 (i.e., K=3) are shown. It is understood that fewer or more steps 202 may be included in grating period 204. It is also understood that fewer or more sub-steps 208 may be included with respect to each step 202. Although one period of sub-steps 208 are shown for each step 202, it is understood that more than one period γ of substeps 208 (i.e. more than one set of monotonically decreasing sub-steps 208) may be provided for each step 202. For example, if two periods of sub-steps 208 are provided on one step 202, color separation grating 200 may diffract incident light 206 to ±5 order diffraction (which further increases the diffraction angle θ).

In general, step width w, step depth d, sub-step width w_{SUB}, sub-step depth d_{SUB}, a number of steps N, a number of sub-steps K, a number of periods γ of sub-steps 208 per step 202, an index of refraction nₒ, and grating period Λ represent grating parameters for grating 200. One or more of the grating parameters may be varied to control the separation of incident light 206 through grating 200 into higher diffraction orders, and to produce a suitable diffraction angle θ.

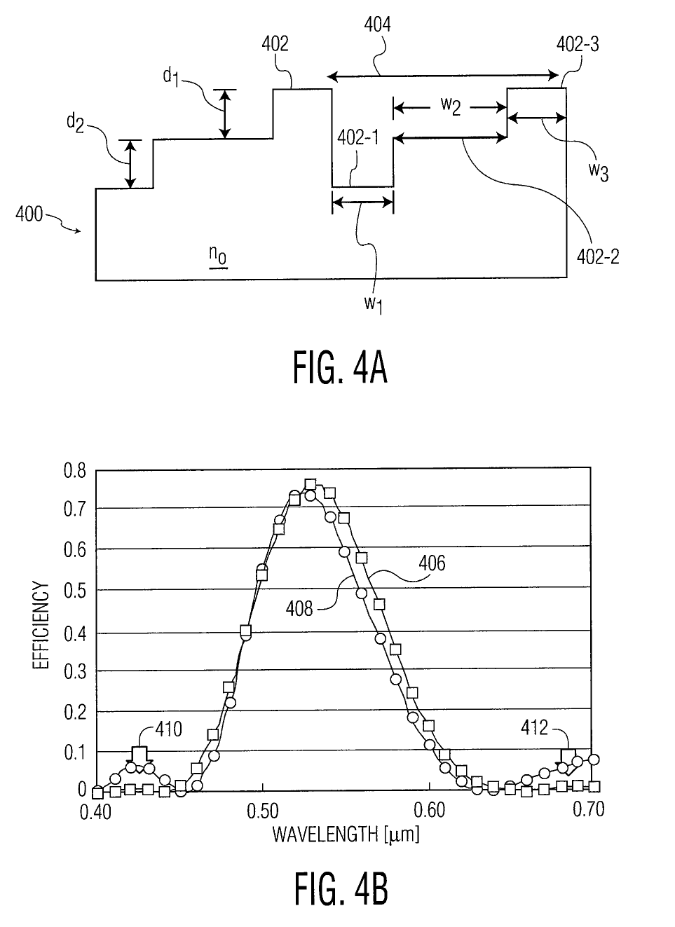

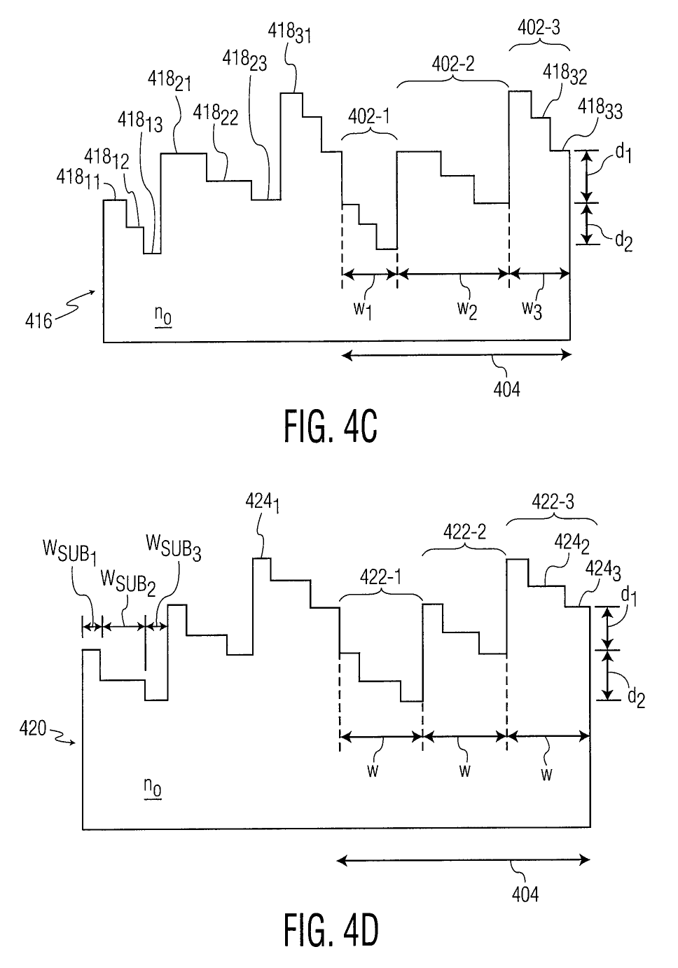

Although steps 202 are illustrated as having a same width w, the width of each step per grating period 204 may be individually varied, for example, to suppress sidelobes in the transmittance characteristic for each diffracted color. An example of a grating with different step widths is described further below with reference to FIG. 4A. In addition, although sub-steps 208 are illustrated as having a same width w_{SUB}, it is understood that individual sub-steps 208 may also have a different width per step 202. Finally, although steps 202 and sub-steps 208 are illustrated as having a same depth, d and d_{SUB}, respectively, it is understood that depths d and/or d_{SUB} may also be individually varied.

Example characteristics of color separation grating 200 are shown below in Table 2 for grating 200 having three steps 202 (N=3) and three sub-steps 208 (K=3). Transmittance efficiency of grating 200 having the grating characteristics shown in Table 2 are described below with reference to FIG. 2B.

TABLE 2
Example characteristics for color separation grating 200

| | | w | d | Λ | w_{sub} | d_{SUB} | d_{TS} |
|---|---|---|---|---|---|---|---|
| Material | nₒ | (μm) | (μm) | (μm) | (μm) | (μm) | (μm) |
| SiO₂ | 1.46 | 2.66 | 2.3 | 8.0 | 0.89 | 1.1 | 2.2 |

Referring to FIG. 2B, a graph of transmittance as a function of wavelength is shown. In particular, transmittance curve 210 of +2 order corresponds to blue light (wavelength of 0.45 μm), transmittance curve 212 of 0 order corresponds to green light (wavelength of 0.53 μm) and transmittance curve 214 of −2 order corresponds to red light (wavelength of 0.64 μm) diffracted through grating 200 (FIG. 2A). As shown in FIG. 2B, color separation grating 200 provides good color separation. Comparing the transmittance curves 210, 212, 214 (FIG. 2B) of grating 200 (FIG. 2A) with the transmittance curves 110, 112, 114 (FIG. 1B) for conventional grating 100 (FIG. 1A), color separation grating 200 provides more uniform transmittance characteristics (i.e. more consistent peak heights) for red, green and blue diffracted light.

Referring to FIG. 3, an exemplary imaging array 300 is shown. Imaging array 300 includes color separation grating 200 having grating period 204, microlenses 302 and pixel array 304. As described above, color separation grating 200 diffracts red, green and blue light to different diffraction orders. Lenses 302 are used to focus the diffracted light 306-B (blue), 306-G (green), 306-R (red) to respective photodetectors 312-B, 312-G and 312-R of pixel array 304. Color separation grating 200 is spaced apart from pixel array 304 by distance D. Distance D may be determined based on the diffraction angle θ and the focusing provided by microlenses 302.

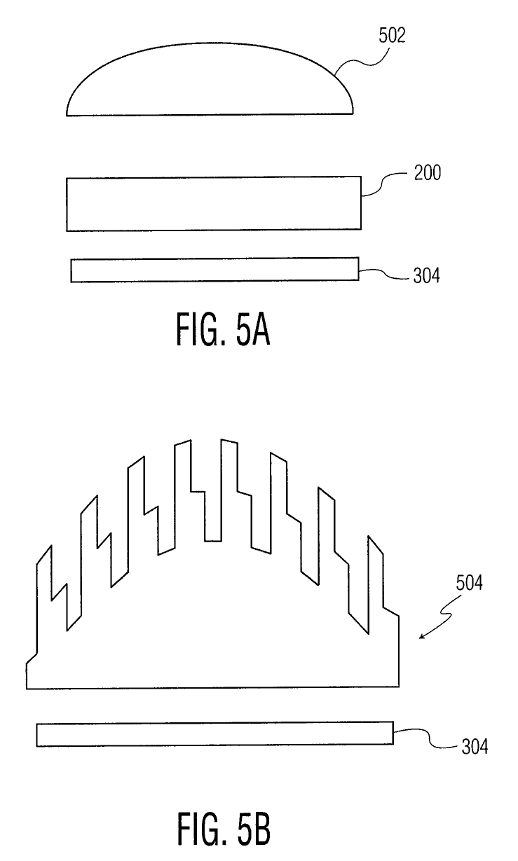

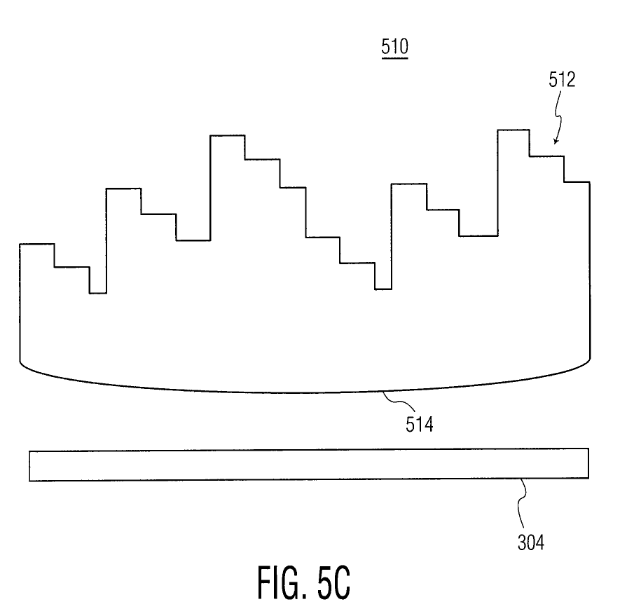

Although microlens 302 is illustrated as being a converging lens, microlens 302 may include any suitable lens, including a diverging lens. Although microlenses 302 are illustrated as being positioned between color separation grating 200 and pixel array 304, microlenses 302 may be formed above color separation grating 200. In addition, microlenses 302 may be integrated with color separation grating 200. Examples of combinations of color separation grating 200 and microlens 302 are described further below with reference to FIGS. 5A, 5B and 5C.

Photodetector 312 may include any suitable sensor for detecting an intensity of light and converting the intensity to an electric signal, such as a photodiode or a photogate. Pixel array 304 may include CMOS and CCD pixels.

Referring next to FIG. 4A, another exemplary color separation grating 400 is shown. Grating 400 includes N steps 402 in each grating period 404. Grating 400 is similar to conventional grating 100 (FIG. 1A) except that steps 402 have different widths. Steps 402-1, 402-2, 402-3 have widths w₁, w₂ and w₃, respectively. Steps 402 may also include different respective depths d₁, d₂.

For example, step 402-3 is illustrated as having a substantially larger width w₂ as compared to widths w_{1,}w₃ of respective steps 402-1, 402-3. By adjusting the individual width of steps 402, sidelobes in the transmittance characteristics may be suppressed, as shown below in FIG. 4B. It is understood that although FIG. 2A shows sub-steps 208 as having equal width w_{SUB}, the width of sub-steps 208 may also be individually varied, similar to FIG. 4A, to improve the resolution of the transmittance efficiency for red, green and blue diffracted light.

Example characteristics of color separation grating 400 are shown below in Table 3 for grating 400 having three steps 402 (N=3). Transmittance characteristics for grating 400 having the grating characteristics shown in Table 3 are described below with reference to FIG. 4B.

TABLE 3
Example characteristics for color separation grating 400

| | | w₁ | w₂ | w₃ | Λ | d₁ | d₂ |
|---|---|---|---|---|---|---|---|
| Material | nₒ | (μm) | (μm) | (μm) | (μm) | (μm) | (μm) |
| SiO₂ | 1.46 | 2.73 | 4.83 | 2.44 | 10 | 2.3 | 2.3 |

FIG. 4B shows the transmittance curves 406, 408 for green diffracted light using respective grating 400 (FIG. 4A) and conventional grating 100 (FIG. 1A). Transmittance curve 406 (for grating 400 shown in FIG. 4A) shows substantial sidelobe suppression in regions 410, 412 as compared with transmittance curve 408 for conventional grating 100 (FIG. 1A).

In FIG. 4C, another exemplary color separation grating 416 is shown. Grating 416 includes N steps 402 in each grating period 404 and K sub-steps 418 per step 402. Grating 416 is similar to color separation grating 200 (FIG. 2A) except that steps 402 include sub-steps 418. Each step 402-1, 402-2, 402-3 has a different width, w₁, w₂ and w₃, respectively. Accordingly, each set of sub-steps 418ₓ₁, 418ₓ₂, 418ₓ₃ also has a different width, where x represents the associated step 402-x. For example, sub-steps 418₂₁, 418₂₂, 418₂₃ (for step 402-2) are wider as compared with sub-steps 418₁₁, 418₁₂, 418₁₃ (for step 402-1), because width w₂ (of step 402-2) is greater than width w₁ (of step 402-1). Steps 402 may also include different respective depths d₁, d₂.

In FIG. 4D, a further exemplary color separation grating 420 is shown. Grating 420 includes N steps 422 in each grating period 404 and K sub-steps 424 per step 422. Grating 420 is similar to color separation grating 200 (FIG. 2A) except that sub-steps 424 have different widths, whereas each step 402-1, 402-2, 402-3 has a same width w. Each sub-step 424₁, 424₂, 424₃ has a different width, w_{SUB1}, w_{SUB2} and w_{SUB3}, respectively. Steps 402 may also include different respective depths d₁, d₂.

Referring next to FIGS. 5A, 5B, and 5C, example combinations of a microlens with a color separation grating having sub-steps are shown. Although FIG. 3 illustrates separate microlenses 302 provided under color separation grating 200, microlenses may be combined with a color separation grating having sub-steps in alternative ways.

FIG. 5A is a cross-section diagram of a microlens 502 formed separately and placed above color separation grating 200 such that color separation grating 200 is between microlens 502 and pixel array 304. FIG. 5B is an integrated color separation microlens 504 that is provided above pixel array 304. Color separation microlens 504 integrates a microlens and color separation grating such that the color separation grating steps and sub-steps each has a curved shape. FIG. 5C is a cross-section diagram of another color separation microlens 510, having a grating 512 on an upper surface and a curved lower surface 514 to provide focusing of diffracted light to pixel array 304, where curved lower surface 514 acts as a diverging lens.

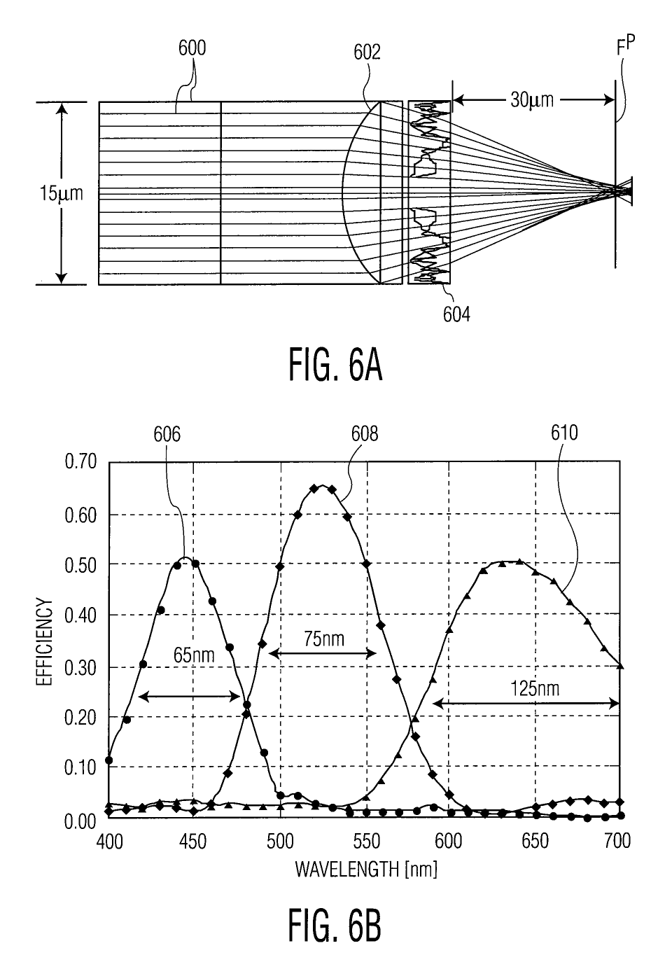

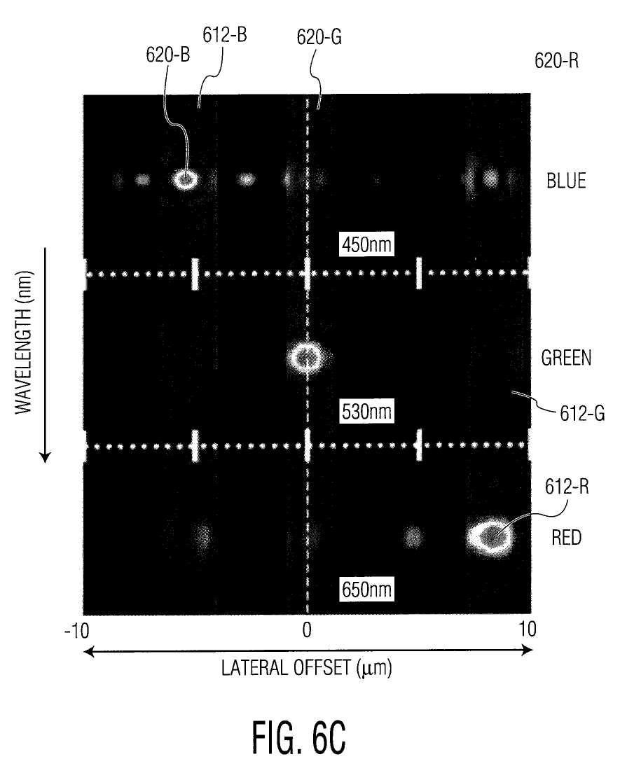

Referring next to FIGS. 6A, 6B and 6C, an example of characteristics for a combined microlens 602 and color separation grating 604 are shown. In particular, FIG. 6A is a ray-trace diagram showing an example illustrating light rays 600 transmitted through microlens 602 and color separation grating 604 to a focal plane (FP); FIG. 6B is a graph of transmittance efficiency for diffracted light as function of wavelength for the combination of microlens 602 and color separation grating 604; and FIG. 6C is an image of focus spots for red, green and blue light passed through microlens 602 and color separation grating 604 as a function of wavelength and relative lateral offset.

In this example, microlens 602 has a diameter of 15 μm, a thickness of 10 μm and a radius of curvature of 0.020986 mm. Microlens 602 is provided in front of color separation grating 604 such that microlens 602 receives incident light rays 600. Grating 604 has a thickness of 7 μm and is positioned 30 μm from focal plane FP.

Example characteristics of color separation grating 604 are shown below in Table 4 for grating 604 having three steps (N=3) and three sub-steps per step (K=3). Transmittance efficiency for grating 608 having the grating characteristics shown in Table 4 are described below with reference to FIG. 6B. Focus spots for grating 608 having the grating characteristics shown in Table 4 are described below with reference to FIG. 6C.

TABLE 4
Example characteristics for color separation grating 604

| | | w | d | Λ | w_{sub} | d_{TS} |
|---|---|---|---|---|---|---|
| Material | nₒ | (μm) | (μm) | (μm) | (μm) | (μm) |
| SiO₂ | 1.45 | 1.16 | 2.3 | 5.0 | 0.38 | 2.3 |

FIG. 6B shows transmittance curves 606, 608, 610 for +2 order (blue light), 0 order (green light) and −2 order (red light) diffraction, respectively. The bandwidth of transmittances curves 606, 608, 610 are about 65 nm (for blue light), about 75 nm (for green light) and about 125 nm (for red light), respectively. As shown in FIG. 6B, transmittance curves 606, 608 and 610 have an average peak height of about 55 percent. Furthermore, sidelobes of transmittance curves 606, 608, 610 are substantially suppressed, and correspond to less than about 6.5% in the transmittance efficiency.

FIG. 6C shows an image of focus spots 612-B (for blue light), 612-G (for green light) and 612-R (for red light) as a function of wavelength and relative lateral offset, for light passed through microlens 602 and diffracted through grating 604. In FIG. 6C, focus spot 612-G represents a 0 μm offset. For blue light, focus spot 612-B is positioned approximately 6 μm to the left of green focus spot 612-G. For red light, focus spot 612-R is positioned approximately 8.5 μm to the right of green focus spot 612-G. In general, blue focus spot 612-B has a width (with respect to lateral position) of 2 μm, green focus spot 612-G has a width of 1.5 μm and red focus spot 612-R has a width of 2.5 μm. Accordingly, photodetectors (represented by vertical bars 620-B, 620-G and 620-R) may be respectively positioned at 6 μm (for blue light), 0 μm (for green light) and at 8.5 μm (for red light) to capture intensities from the respectively diffracted colors. In FIG. 6C, focus spots 612-B, 612-G and 612-R were obtained separately by passing respective blue light, red light and green light through combined microlens 602 and grating 604.

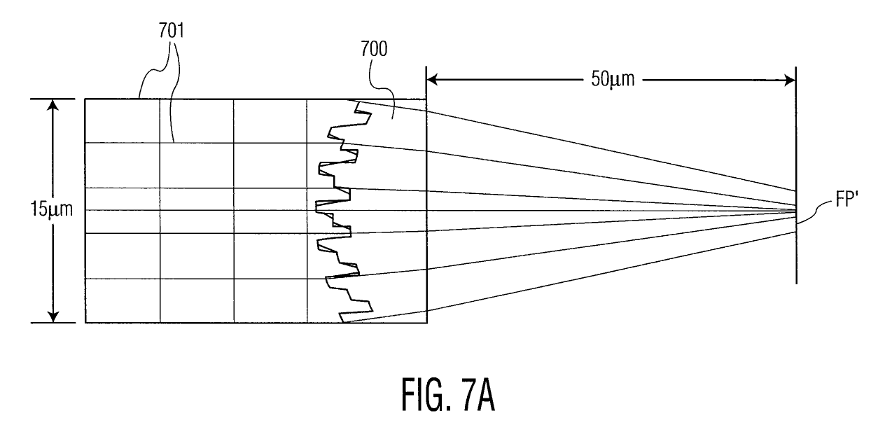

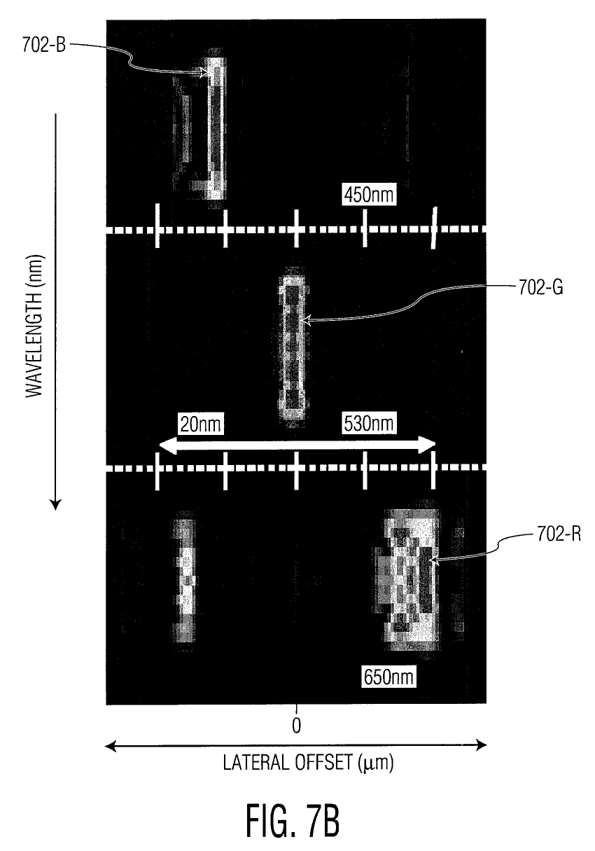

FIGS. 7A and 7B show an example of characteristics for another exemplary color separation microlens 700 which may be the microlens shown in FIG. 5B. In particular, FIG. 7A is a ray-trace diagram showing an example illustrating light rays 701 passed through color separation microlens 700; and FIG. 7B is an image of focus spots for red, green and blue light passed by color separation microlens 700 as a function of wavelength and relative lateral offset.

As shown in FIG. 7A, color separation microlens 700 includes an integrated microlens and grating structure, where the grating is curved. Color separation microlens 700 has a diameter of 15 μm and is positioned 50 μm from focal plane FP′. The grating structure of color separation microlens 700 has a thickness of 15 μm, a grating height of 4.6 μm, a grating period of 3.5 μm and a radius of curvature of 0.02716 mm. Although not illustrated, color separation microlens 700 has three steps per grating period (N=3) and no sub-steps per step (i.e., K=1).

FIG. 7B illustrates focus spots 702-B (blue light), 702-G (green light) and 702-R (red light) as a function of wavelength and relative lateral offset relative to focus spot 702-G. In FIG. 7B, focus spots 702-B, 702-G and 702-R were obtained separately by passing respective blue light, red light and green light through color separation microlens 700. FIG. 7B represents a combination of three images presented as one image. Comparing FIG. 7B with FIG. 6C, focus spots 702 are generally broader than focus spots 612. In addition, focus spots 702-B, 702-R have a greater lateral offset as compared with focus spots 612-B, 612-R.

Several embodiments of the invention have been described herein. It is understood that the present invention is not limited to these embodiments and that different embodiments may be used together.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A color separation grating comprising:
a transparent grating material having a grating formed therein, the transparent grating material having a first surface configured to receive incident light and a second surface opposite the first surface, the second surface configured to pass selective separated colors from the incident light corresponding to different diffraction orders,
wherein the grating is formed in the first surface and includes a number of steps in a grating period and a number of sub-steps formed on each step, and
wherein a combination of the number of steps and the number of sub-steps are selected to correspond to a number of diffraction orders produced by the color separation grating.

2. A color separation grating according to claim 1, wherein a height of each step increases in a predetermined direction over the grating period and a height of each sub-step decreases in the predetermined direction over each step.

3. A color separation grating according to claim 1, wherein the color separation grating diffracts the separated colors to different diffraction angles corresponding to the number of diffraction orders.

4. A color separation grating according to claim 1, wherein the number of the diffraction orders produced includes at least a −2 order, a 0 order and a +2 order.

5. A color separation grating according to claim 1, wherein the number of the diffraction orders produced includes at least a −5 order, a 0 order and a +5 order.

6. A color separation grating according to claim 1, wherein each step has a same width over the grating period.

7. A color separation grating according to claim 1, wherein each sub-step has a same width across each step.

8. A color separation grating according to claim 1, wherein at least one of the steps has a different width relative to the remaining steps in the grating period.

9. A color separation grating according to claim 8, wherein the diffraction orders have respective transmittance efficiencies relative to wavelength and the different width of the at least one of the steps is selected to substantially suppress sidelobes in the respective transmittance efficiencies.

10. A color separation grating according to claim 1, wherein at least one of the sub-steps has a different width relative to the remaining sub-steps in each step.

11. A color separation grating according to claim 1, wherein the color separation grating includes a transmission grating.

12. A color separation grating according to claim 1, wherein the number of steps is at least three and the number of sub-steps is at least three.

13. A color separation grating according to claim 1, wherein each step includes one or more periods of sub-steps.

14. A color separation grating according to claim 13, wherein each step includes two periods of sub-steps and the number of the diffraction orders produced includes a −5 order, 0 order and a +5 order.

15. A color separation grating according to claim 1, wherein the color separation grating includes grating parameters comprising: a step width, a step depth, a sub-step width, a sub-step depth, a number of periods of sub-steps per step, and
the diffraction orders have respective transmittance efficiencies relative to wavelength controlled by at least one of the grating parameters.

16. A color separation microlens comprising:
a color separation grating including:
a transparent grating material having a grating formed therein, the transparent grating material having a first surface configured to receive incident light and a second surface opposite the first surface, the second surface configured to pass selective separated colors from the incident light corresponding to different diffraction orders, the grating formed in the first surface and including a number of steps in a grating period and a number of sub-steps formed on each step; and
a lens positioned either proximate the first surface or proximate the second surface and configured to focus the different diffraction orders onto respective separate focus spots on a common focal plane relative to the color separation grating,
wherein a combination of the number of steps and the number of sub-steps is selected to correspond to a number of diffraction orders produced by the color separation grating.

17. A color separation microlens according to claim 16, wherein the number of the diffraction orders produced includes at least a −2 order, a 0 order and a +2 order.

18. A color separation microlens according to claim 16, wherein a height of each step increases in a predetermined direction over the grating period and a height of each sub-step decreases in the predetermined direction over each step.

19. A color separation microlens according to claim 16, wherein the color separation grating includes grating parameters comprising: a step width, a step depth, a sub-step width, a sub-step depth, a number of periods of sub-steps per step, and
the diffraction orders have respective transmittance efficiencies relative to wavelength controlled by at least one of the grating parameters.

20. A color separation microlens according to claim 16, wherein the number of diffraction orders includes three and the selective separated colors include red, green and blue.

21. A color separation microlens according to claim 16, wherein the lens includes a lens surface for focusing the different diffraction orders into the respective separate focus spots.

22. A color separation microlens according to claim 21, wherein the color separation grating is formed with the lens as an integrated microlens and the first surface and the lens surface are combined in a single surface of the integrated microlens.

23. A color separation microlens according to claim 21, wherein the color separation grating is formed with the lens as an integrated microlens and the second surface and the lens surface are combined in a single surface of the integrated microlens.

24. An imaging array comprising:
a color separation grating having a plurality of grating periods, the color separation grating including:
a transparent grating material having a grating formed therein, the transparent grating material having a first surface configured to receive incident light and a second surface opposite the first surface, the second surface configured to pass selective separated colors from the incident light corresponding to different diffraction orders, the grating formed in the first surface and including a number of steps in each grating period and a number of sub-steps formed on each step;
a plurality of microlenses positioned either proximate the first surface or proximate the second surface and configured to focus the different diffraction orders onto respective separate focus spots on a common focal plane relative to the color separation grating; and
a plurality of photodetectors positioned at the separate focus spots to receive the respective different diffraction orders,
wherein a combination of the number of steps and the number of sub-steps is selected to correspond to a number of diffraction orders produced by the color separation grating.

25. An imaging array according to claim 24, wherein the plurality of microlenses are formed integrated with the color separation grating.

26. A color separation grating according to claim 24, wherein the color separation grating includes grating parameters comprising: a step width, a step depth, a sub-step width, a sub-step depth, a number of periods of sub-steps per step, and the diffraction orders have respective transmittance efficiencies controlled by at least one of the grating parameters.

27. An imaging array according to claim 24, wherein a height of each step increases in a predetermined direction over the grating period and a height of each sub-step decreases in the predetermined direction over each step.

28. An imaging array according to claim 24, wherein the number of the diffraction orders produced includes at least a −2 order, a 0 order and a +2 order.

29. An imaging array according to claim 24, wherein the number of the diffraction orders produced includes at least a −5 order, a 0 order and a +5 order.

30. A color separation grating according to claim 24, wherein the number of diffraction orders includes three and the selective separated colors include red, green and blue.

31. An imaging array according to claim 24, wherein each microlens includes a lens surface for focusing the different diffraction orders onto the respective separate focus spots.

32. An imaging array according to claim 31, wherein the color separation grating is formed with the plurality of microlenses as an integrated microlens array and the first surface and each lens surface are combined in a single surface of the integrated microlens array.

33. An imaging array according to claim 31, wherein the color separation grating is formed with the plurality of microlenses as an integrated microlens array and the second surface and each lens surface are combined in a single surface of the integrated microlens array.
